(19) United States
(12) Patent Application Publication
(10) Pub. No.: US 2011/0005842 A1
(43) Pub. Date: Jan. 13, 2011

(54) Food Scale that measures specific volume and weight from preprogrammed densities while compiling nutritional data of used ingredients from stored data.

(76) Inventor: Frank Chan, El Cajon, CA (US)

Correspondence Address: Frank Chan, 570 S. Mollison Ave, Apt. 29, El Cajon, CA, 92020, US

(21) Appl. No.: 12/501,465

(22) Filed: Jul. 12, 2009

(51) Int. Cl. G01G 19/40

(52) U.S. Cl. 177/25.14

(57) ABSTRACT

Scale that can measure volume of many foods and ingredients based on density calculations and input of mass from scale. User able to input desired quantity, unit of measurement, and food item by both keypad on unit and or voice recognition. User is then guided to the addition of specified ingredient to targeted amount by visual and auditory indication. The food scale compiles the nutritional information of all used ingredients from programmed nutritional data for the user's knowledge. The food scale is capable of listing ingredient substitutions and storing recipes as well as prompting for additional ingredients in a preprogrammed recipe.

### BACKGROUND AND DESCRIPTION

Many recipes for food and other mixtures call for specific amounts of many ingredients, without the exact amount, the prepared product can be undesirable. Many ingredients also have to be measured by correct procedure otherwise the incorrect amount becomes measured. Traditionally, a food preparer must use a measuring tool such as a measuring beaker or many specific measuring cups and spoons. The necessity to prevent cross contamination required many sets of measuring devices or continuous cleaning and drying of used measuring devices. By the device presented here, a user can measure the desired volume of an ingredient by inputing the quantity, unit of measurement and name of ingredient and then adding the ingredient to the scale until a calculated mass (from programmed food density data) is reached. A user can drastically reduce work time, used materials, and also increase accuracy. The need to prevent cross contamination, cut work and cleanup time, and maximize accuracy is especially important to commercial food preparers such as restaurants and food manufacturers.

For example: A user can place a mixing bowl on the scale and then zero the scale. The user then specifies an exact volume of ingredient needed by keypad or voice recognition, such as 1 cup of flour. The on-board computer can immediately determine an exact mass of flour needed to reach the volume of 1 cup. The user then adds flour directly from the flour container to the mixing bowl as the visual and auditory indicators is indicating approach of targeted mass which the user then stops adding the ingredient. Since the ingredient was poured directly from the source, there is no extra item used to measure or transfer materials, saving time and cleanup. The user can continue to zero the scale and add specific amounts of ingredients while maintaining accuracy. After all ingredients are added, the used ingredient's nutritional data is compiled and the nutritional information of the prepared product can be displayed to the user. This will make clear to the user the nutritional value of the food that is being prepared comparable in accuracy to commercially produced and labeled food items. Viable substitutions can be offered during the creation of a recipe to allow the user to substitute ingredients due to availability or health and diet reasons. Recipe books and personal recipes can be shared and used by utilizing external computer media such as USB drive.

### SPECIFICATION AND SUMMARY

Scale that is capable of tare or zero. Scale mass measurements output to computer. Computer stores food densities, nutritional values, viable substitutions, and recipes. User inputs desired volume of an ingredient by voice or keypad. Scale then calculates the proper mass from the stored density data: Density=Mass/Volume. Computer then reads the mass output from the scale and alerts the approach of the necessary mass. Nutritional data is compiled and displayed when the user has completed the addition of ingredients. Custom ingredients and recipes can be stored in the scale's computer. Physical size and design to look similar to current food scales and scales, the addition of an on-board computer would add minimally to the size compared to current scales. The addition of the keypad and audio input device to the scale would also be similar in appearance to current digital scales. The scale's body is made of a hard material such as plastic, metal, or glass. The front face houses the keypad for ingredient entry and should be a sealed system to prevent leaking of materials into the scale's body. The voice input microphone can be located anywhere convenient and protected from spills on the scale's body. The scale's measuring component sits atop the scale body parallel to the ground or table. A computer capable of input, display, calculations and storage is housed in the scale body.

1. Scale with preprogrammed densities and nutritional data of many food items and other ingredients by on-board computer, capable of taking user input to calculate desired mass from known densities and can take input of custom ingredients and recipes to the on-board computer while having a means to alert the approach of the desired amount of ingredient.

2. On-board computer of claim 1 is capable of unit conversions between most known densities, mass, and volume.

3. User input of claim 1 allows user input of desired quantity, unit of measurement, and ingredient by keypad consisting of a set of numerical keys to input quantity, keys of many common volumes and masses, and condensed or full alphabetic keys to input name of ingredient.

4. User input of claim 1 is user input of desired quantity, unit of measurement, and ingredient by voice recognition.

5. On-board computer's ability to calculate desired mass from known density of claim 1 is accomplished by using programmed unit conversion factors, programmed ingredient densities and from user input of desired quantity of ingredient.

6. Scale's means of alert in claim 1 is visual in the form of a decreasing status bar of lights to alert to the approach of target mass.

7. Scale's means of alert in claim 1 is auditory in the form of increasing frequency of beeps to the point of a constant beep to alert to the approach of target mass.

8. User input of custom ingredients of claim 1 is accomplished by inputing title and then measuring the mass of a specified volume to form a baseline density.

9. Scale maintains total nutritional data of all used ingredients as compiled from the nutritional data of claim 1 to inform user of total nutritional information.

10. Scale capable of repeated “tare” or “zero out” to allow continuous additions to the scale.

11. Scale capable of storing user recipes and ingredients as well as preprogrammed recipes of claim 1 by direct input or external computer media.

12. Scale prompts ingredient addition if following a programmed recipe of claim 11.

14. Scale prompts ingredient substitutions for recipes of stored recipes of claim 11.
